(19) United States
(12) Patent Application Publication
(10) Pub. No.: US 2005/0193932 A1
(43) Pub. Date: Sep. 8, 2005

(54) Safe lock with motor controlled bolts and electronic access

(75) Inventors: William D. Denison, Lake Zurich, IL (US); Gary L. Myers, Monee, IL (US); Calin V. Roatis, Long Grove, IL (US); Richard Paeth, St. Charles, IL (US); Catalin Captarencu, Wheeling, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: TriTeq Lock and Security, L.L.C., Elk Grove, IL (US)

(21) Appl. No.: 11/073,184

(22) Filed: Mar. 3, 2005

Related U.S. Application Data
(60) Provisional application No. 60/550,801, filed on Mar. 5, 2004.

(51) Int. Cl. E05G 1/04; E05B 49/00

(52) U.S. Cl. 109/59 R

(57) ABSTRACT

An enhanced bolt control system for safes and the like utilizes a reversible motor and worm gear drive that operates the deadbolt linkage. An electronic control with a microcomputer interface drives the motor control and the system may be operated by a keypad or a remote wireless control device.

### FIELD OF THE INVENTION

The present invention relates generally to safe lock systems that control the movement of the deadbolts such as in a conventional security safe. More specifically the invention provides an enhanced bolt control, and it may also incorporate a unique access control device such as a keypad access control and/or a remote control device that transmits codes in a wireless medium.

This application claims priority from provisional application Ser. No. 60/550,801, filed Mar. 5, 2004 and incorporates herein by reference.

### BACKGROUND OF THE INVENTION

Safes today are typically secured with a mechanism comprising of deadbolts or the like in the door, which generally extend into the cabinet frame when locked, the motion going from unlocked to locked is typically controlled by a rotate-able exterior mounted handle controlled by a mechanical controlled or electronic controlled lock-box mechanism. The handle is prevented from rotating by a mechanism that is accessed by either an electronic keypad or mechanical dial combination lock. For example, a deadbolt configuration consisting of one or more deadbolt(s) that is in a retracted position while the door is open and as the door is being closed. Once the handle is pushed and the door is in the closed position, the operator takes the handle and rotates it typically 90 or 180 degrees (depending on the stroke of the deadbolts) and the deadbolts will extend into or behind the cabinet frame to lock the safe door in place. The lock-box bolt will extend and will stop the mechanism from rotating back to the unlocked position until accessed. To unlock, first the access control device is accessed, the lock-box bolt is (either electrically or mechanically) retracted, and next the handle is rotated back to the open position (or, the bolt retracted position), and last the handle is pulled so the door will open. These methods are typically cumbersome and time consuming. In addition, a safe as described above will typically have an unattractive looking handle and dial or keypad lock mounted to the exterior of the door.

The object of this invention is to improve on the methods, operation, and the interface of locking and the safe unlocking as described above. In addition, the removal of certain components from the outside of the safe door will add to the improvements mentioned by providing enhanced security due to a more difficult point of attack and also provide additional exterior surface area to add decorative features to the safe door.

Although the preferred embodiment of the invention will describe a door with bolts interfacing to a cabinet to receive the bolts, this invention will also support the opposite arrangement such as bolts in a cabinet that interface into the door frame, as well as many other types of door, cabinet, and mechanisms arrangements as are available.

### BRIEF SUMMARY OF THE OBJECTS OF THE INVENTION

The first object is to improve the locking and unlocking of the door by removing the need for a handle and a lock-box with a bolt.

The second object is to replace manual movement of the locking bolts with motor control movement of the lock bolts. The third object is to provide a less user interactive procedure and an easier interface to access and lock the safe.

The forth object is to provide a faster method for accessing and locking the safe.

The fifth object is to improve the security of the door and remove the point of attack by removing the need for an access control unit (keypad or dial) from the door and replace with a remote or removable keypad transmission device.

The sixth object is to provide a more user-friendly electronic controlled device to access and lock the safe door.

The seventh object is to provide the above-described features with a device that is battery powered, although the invention is not limited to battery controlled operation.

### BRIEF DESCRIPTION OF THE DRAWINGS

FIG. 1 is a rear plan view of a safe door and frame showing a prior art bolt system and lock-box in a locked position;

FIG. 2 is a view similar to FIG. 1 showing the prior art bolt system and lock-box in an unlocked position;

FIG. 3 is a rear plan view of a safe door showing the inclusion of the present motor controlled system invention in a locked position;

FIG. 4 is a view similar to FIG. 3 showing the present invention in an unlocked position;

FIG. 5 is a partial rear plan view of the enhanced motor controlled locking system;

FIG. 6 is a partial side plan view of the enhanced motor controlled locking system in FIG. 5; and

FIG. 7 is a partial rear plan view of the enhanced motor controlled locking system in FIGS.

FIG. 8 is a flowchart of the locked to unlock operation.

FIG. 9 is a flowchart of the unlock to lock operation.

FIG. 10 is a flowchart of locked to unlocked with optional receiver sensor.

FIG. 11 is a flowchart of unlocked to locked with optional receiver sensor.

### DETAILED DESCRIPTION OF THE INVENTION

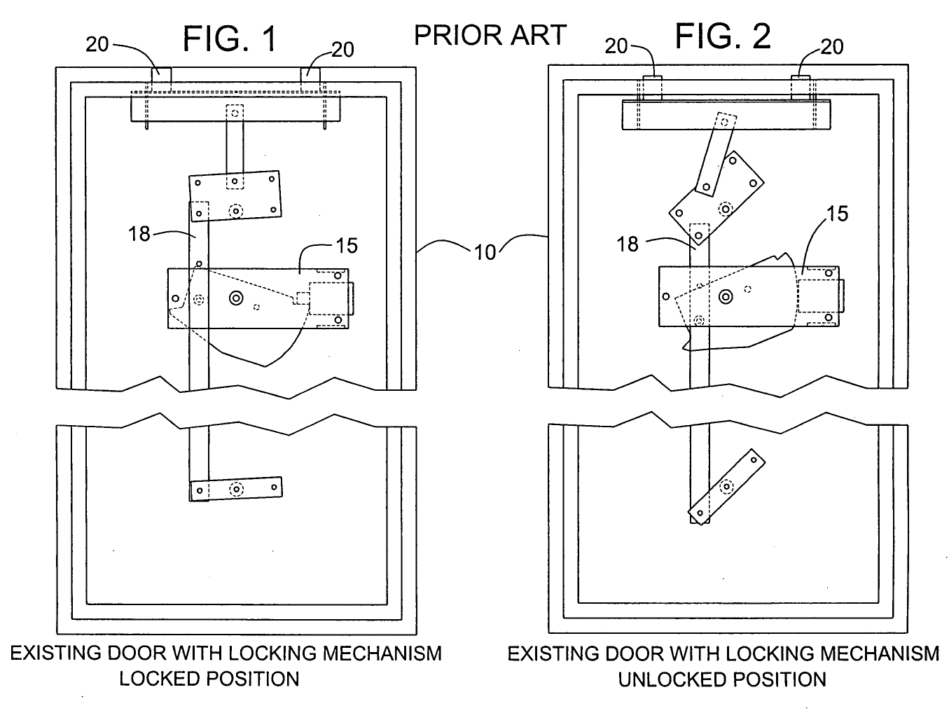

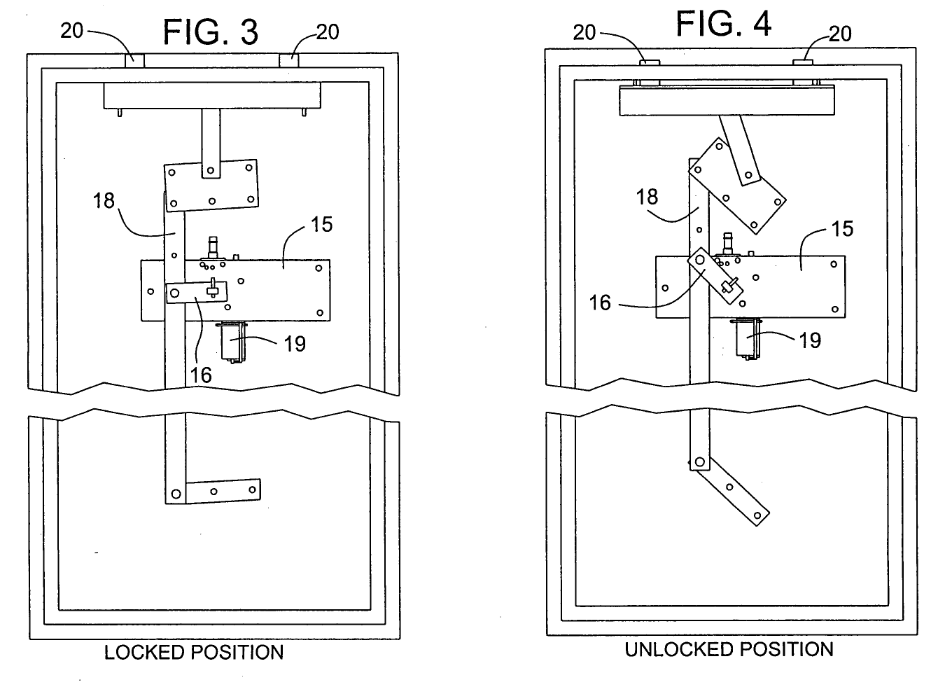

The prior art is illustrated in FIGS. 1 and 2. It would typically consist of rotatable exterior handle, shaft for said handle that passes thru the door (not shown), a pawl or cam device mounted in the interior space on the shaft, a mechanical “lock box” 15 that houses a mechanism that interfaces 18 with a exterior dial or key pad to allow a ‘bolt’ 20 to interact with the above pawl or cam in manner as to prevent rotation.

This invention consists primarily of a motor controlled mechanism to control the movement of the lock bolts in the safe door, an electronic control interface to the motor mechanism, an access control device, and a power source.

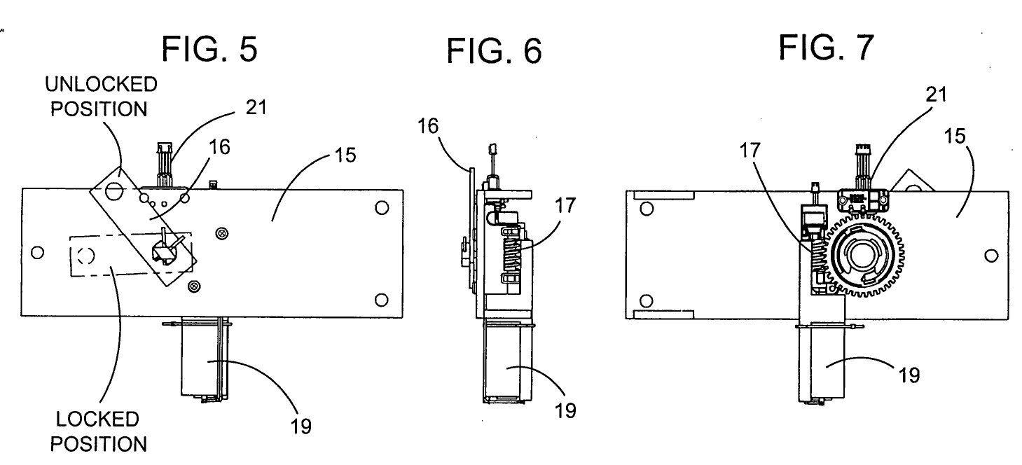

The motor control mechanism is best shown in FIGS. 5, 6 and 7. It serves to eliminate the handle drive system in safes, as they exist today. The motorized lock provides a motor 19 to gear reduction system 17 that allows adequate power to control and move the mechanism, and also will hold back several hundreds of pounds of pry pressure if a vandal were to attempt to rotate a locked mechanism back to the unlocked position by using a pry bar or other tool to push the extended bolts back to the retracted position. This is accomplished by gear reducing the motor rotation first through smaller metal gears in the motor mounted gearbox then to a worm-gear 17 to helical gear 21 arrangement. The helical gear is interfaced to at least 2 teeth of the worm gear to hold back a considerable force from an external device which tries to push in the mechanism and bolt.

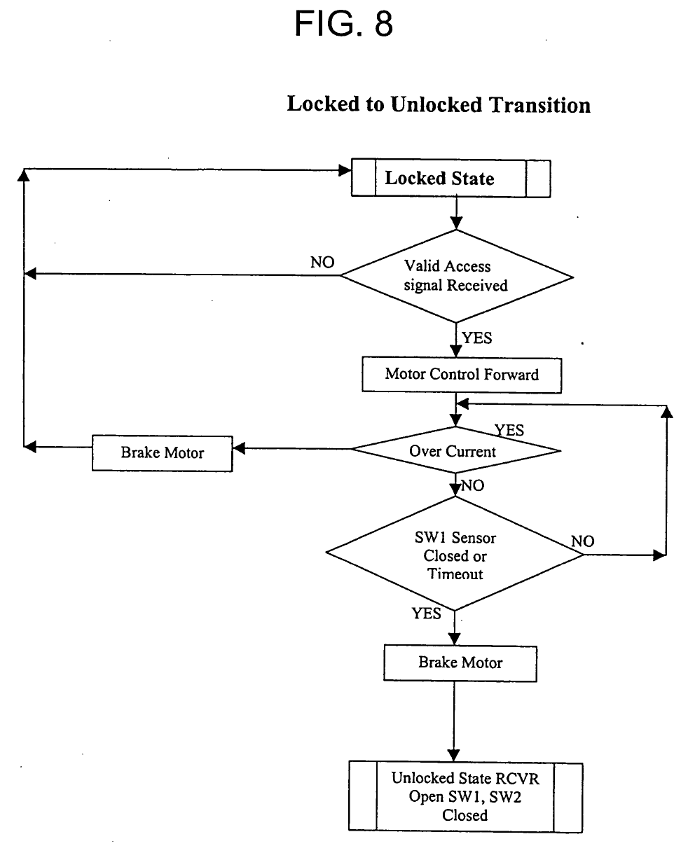

In accordance with the present invention, an electronic control interfaces to the motor 19 and position switches of the motor mechanism. It will control the mechanism by a microcomputer by either driving the mechanism motor in two directions (forward and reverse) or a single direction to move the bolts in and out of the locked position (retracted and extended). The flow-chart drawings 8 and 9 shows a mechanism control using forward/reverse motor control and position sensors. Both the locking and unlocking modes of operations are triggered by a signal from the access control device and the controller operates the motor per the sensor switches, motor current monitoring, and timers as described. The flow-chart drawings 10 & 11 describe locking and unlocking modes of operation if a door-closed and/or a receiver switch sensor is used to detect the door in the closed position to automatically trigger the locking sequence. As in FIGS. 8 & 9, the controller operates the motor per the sensor switches, motor current monitoring, and timers as described.

A further feature considers general safety of the safe operation, when the motor control unit attempts to energize the motor in order to move the bolts in either the locked or unlocked position and if either an impediment or a doorjam or a shorted motor condition occurs where the motor current crosses a certain limit to indicate the bolts are not moving, the motor control unit senses this condition and ceases to drive the motor. If this occurs at the beginning of the lock cycle (within approximately the first 30 degrees of gear rotation) the motor control unit will measure this and if it senses that the bolts are jammed from moving, the motor will reverse in order to return the mechanism back to the fully retracted position. After 30 degrees of gear movement if the motor current is exceeded, the motor control will simply de-energize the motor and will not attempt to reverse the movement of the bolts, thus the safe door will remain in the locked position. If an unlock signal is later received, the motor controller will proceed to retract the bolts and unlock the safe.

In the event that a position switch is faulty, the controller is programmed with fault tolerant or default control logic to control the mechanism and allow the door to unlock if in fact a correct access code is received, even if the mechanism sensing is faulty.

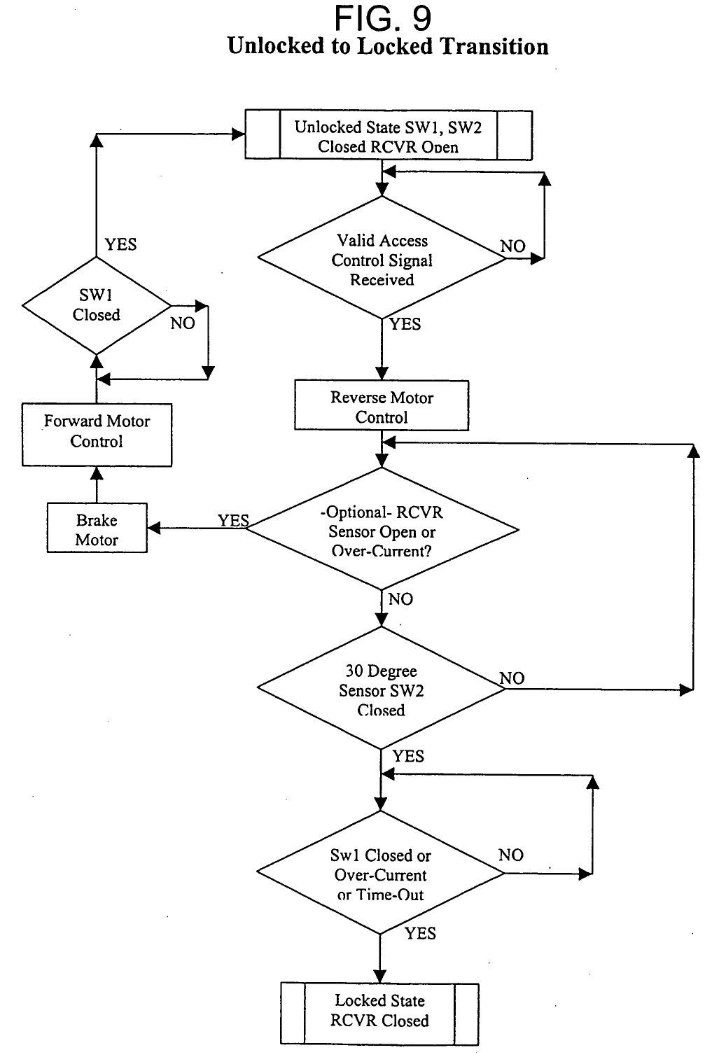

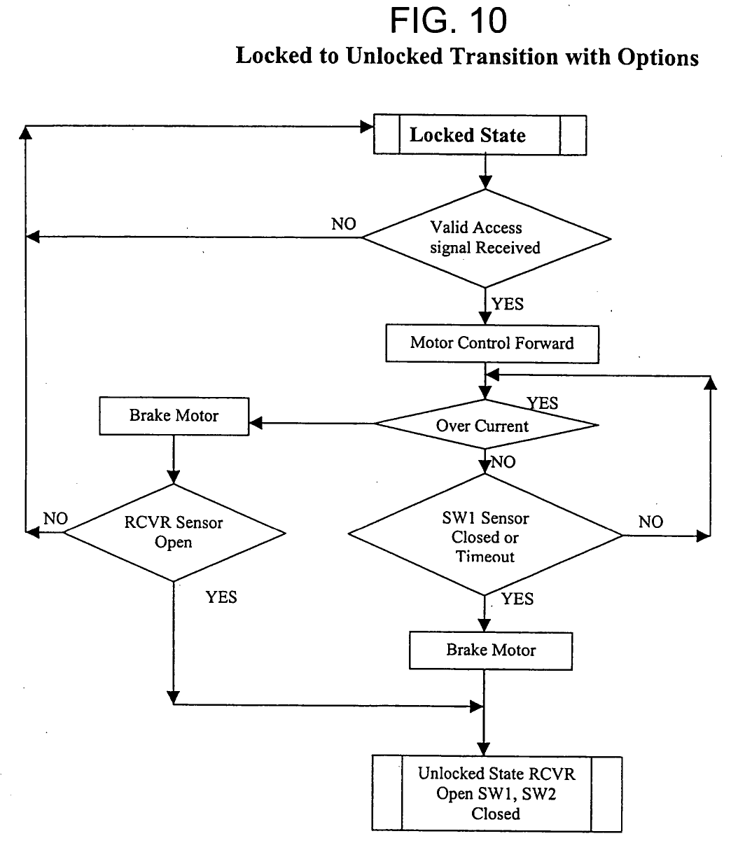

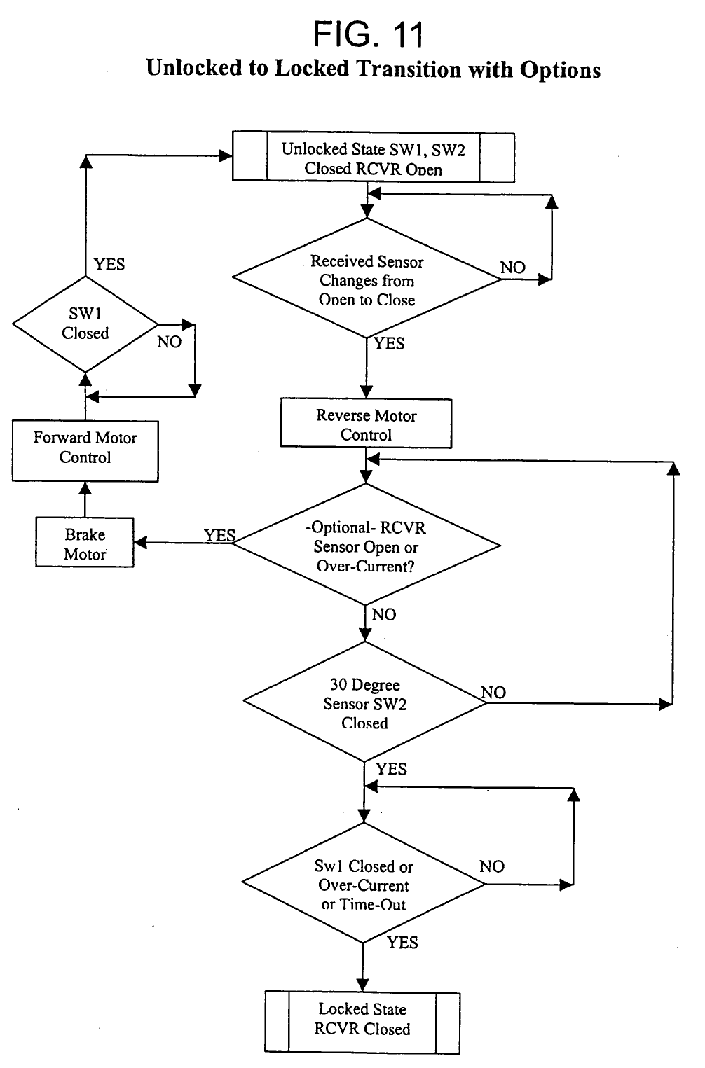

As described in FIG. 9, in the preferred embodiment the locking event for the safe door is controlled by an access signal from the access control unit. In an alternative embodiment as described in FIG. 11, locking is triggered by a simple position switch (FIG. 5, item 21) which measures the position of the door, which produces the lock trigger signal when the door moves from the open to the closed position. In all cases, the access control unit (when it receives a valid access code via a keypad or a remote unit) provides the trigger to unlock the bolts. Examples of keypad and remote controlled access control units are described in U.S. Pat. Nos. 5,617,082 and 6,359,547.

In the case where a keypad lock mounted to the safe is used to access the motor control as described in the patent numbers above, the keypad lock will offer a simple user interface of keys (such as 12 access buttons) and LED lights and/or an LCD display to help the user enter access control commands, enter additional access codes, check the health of the battery, etc.

In the event an access control unit is desired that has no point of attack, a wireless remote control device may be used. Such a wireless access device is also described in U.S. Pat. No. 5,617,082, and this device also offers a battery-saver feature to reduce power consumption of the lock as it is waiting to receive an access code transmission. Two examples of wireless mediums used for this device are radio frequency and infrared. In radio frequency, the antenna of the safe access electronics must be in range of where the remote transmitter is used. In infrared, the infrared pin diode must be in optical range of where the remote transmitter is used. This battery saver feature can be utilized in a number ways: a) full-time when batteries are used to power the lock; b) not at all when the power to the lock is a DC power source; c) a combination of the two modes, wherein power saver mode is used when it is not expected that the lock will be immediately accessed or re-locked, and full-power mode when it is expected that the lock may be immediately accessed or re-locked. One less desirable feature of the battery saver feature is a time-delay reaction to the lock/unlock access input. The advantage to the dual mode of operation is to take advantage of the power-saver during the long time periods the lock most likely is not being locked or unlocked, and to take advantage of the full power mode to react the fastest to the lock/unlock access control signal.

The wireless access control device may take on one of many forms, such as a remote transmitter with a single access code transmit button. When the single transmitter button is pressed, the complete access code is instantly transmitted to the safe access control receiver. Or alternately, the wireless device may use a biometric input such as fingerprint ID to replace a single button as the interface device.

The remote unit can also be a unit with several keypad buttons made up of several digits (for example, 0-9) to allow a user to enter multiple number of button input combinations to make up an access code. As each button is pressed, an individual unique code representing that button is transmitted to the safe access control unit. The order and combination of the codes received from the remote make up the access code for the safe. An example of such a device is known as a universal remote control unit for a television and/or other consumer electronics. Such units typically contain a 0-9 keypad; in these devices each key press results in a unique code transmission. The combination and order of the button presses (for example, 5 presses consisting of 1-3-5-7-9) will make up a unique access code transmission to the safe access control unit.

In the example above using the universal remote control unit, a problem exists with annunciation and user friendly operation of the lock. For example, the universal remote typically contains only an LED light indicating a button was pressed and a code was transmitted, but there is no consideration or confirmation that such key press of a particular code was received by the safe access control unit. Thus, this invention offers two possible solutions to this problem.

1. The safe access control unit can contain annunciation such as LED lights, an LCD display or an audio annunciator (just for a few examples) to provide feedback for the user as to exactly how many keypresses are being received by the remote transmitter. Note, these annunciations do not give any positive or negative feedback of whether the code received was valid or invalid, only that it was received. It will also attempt to annunciate the order that each code is received. For example, if the expected code is 5 digits in length, the annunciator may attempt to either light or un-light an LED for each code received, providing both feedbacks that the code was received and what receiving sequence this code was in as it was received. Typically, this annunciation would be located such that it can be viewed from just in front of the safe door (from 0 to 10 feet back from the door). In addition, other messages may be displayed such as the complete correct code was received, an incorrect complete code was received, the battery is low, an incorrect button was pressed, the mechanism should be unlocking, etc.

2. The safe access control unit can contain a transmission system (typically the same transmission medium as the remote unit) and the remote transmission unit can contain a wireless receiver system to receive the annunciation messages from the access control unit. The same annunciation components such as LED's, LCD, and/or audio indicators can be used at the remote unit. Thus, the user would transmit a code via the control unit, if received the access control would transmit back a confirmation to the remote unit, the remote unit will display an annunciation message to the user that the code was received. In addition, other messages may be displayed such as the complete correct code was received, an incorrect complete code was received, the battery is low, an incorrect button was pressed, the mechanism should be unlocking, etc.

This lock system can be power either by battery source or an AC or DC power source. If batteries are used, it is assumed they are mounted inside the safe and not accessible while the safe door is locked. The batteries shall be monitored for their health and the health will be measured and annunciated to the user as the safe is being accessed or locked (also described in U.S. Pat. No. 6,359,547). The batteries will usually be alkaline non-recharge type, although rechargeable types are possible to use.

In the event the batteries are to low to operate the unit, the preferred embodiment has a power input port that will accept a back-up power supply source to power the safe to allow the lock mechanism to unlock if a correct access code is received. This port does not provide a hotwire to over-ride the access control system of the lock. Once such battery-back-up unit is described in our U.S. patent application Ser. No. 60/523,505. Or, in some cases it may be possible to use a simple 9-volt battery.

The lock also provides an over-ride system in case the electronics fails (either the access control or the motor control unit) by providing access to the motor wires if the safe is drilled in a certain location. Once gaining access to these wires, the motor can be energized independent of the access control and motor control circuits and the lock bolts will retract so the door can be opened. This will allow the faulty lock components replacement without serious damage of the safes primary structure.

1. A locking system for safes and the like wherein a door is locked and unlocked to a cabinet, comprising in combination, a motor means carried either by the door or cabinet, said motor means rotatably connected to a mechanical linkage having locked and unlocked positions, and control means for driving said motor to move said linkage from the locked to the unlocked position.

2. A locking system as claimed in claim 1, wherein said motor means is driven to move said linkage from the unlocked to the locked position.

3. A locking system as claimed in claim 1, wherein said motor is a two-direction reversible motor.

4. A locking system as claimed in claim 1, wherein said locked position of said linkage is force resisting.

5. A locking system as claimed in claim 1, wherein said motor means drives said mechanical linkage means through gear reduction means.

6. A locking system as claimed in claim 5, wherein said gear reduction means includes first reduction gears, and a second gear reduction means.

7. A locking system as claimed in claim 6, wherein said second gear reduction means includes a worm gear and a helical gear.

8. A locking system as claimed in claim 7, wherein said helical gear is interfaced to at least 2 teeth of the worm gear.

9. A locking system as claimed in claim 4, wherein said motor means includes an access control means.

10. A locking system as claimed in claim 9, wherein said access control means is remotely operable.

11. A locking system as claimed in claim 9, including an override means for energizing said motor independent of said motor control means and access control means.

12. A locking system as claimed in claim 9, wherein the control means and motor are powered by a battery source.

13. A locking system as claimed in claim 9, wherein position switch means provides a lock trigger signal for energizing said motor to lock the deadbolt means.

14. A locking system as claimed in claim 9, wherein said access control means is operated by an access input means carried by the door or cabinet.

15. A locking system as claimed in claim 4, wherein sensing means is included for said motor to detect motor current and either reverse the motor direction or deenergize the motor upon reaching predetermined current levels.

16. A locking system as claimed in claim 9, wherein said access control means is operable only by input of a unique preset access code signal.

17. A locking system as claimed in claim 9, wherein said control includes a battery saver sleep mode and an operational mode upon input of an access signal.

18. A method of unlocking a door to a cabinet wherein deadbolt means is carried by either the door or cabinet and mechanical linkage means moves the deadbolt means for unlocking the door with the cabinet comprising providing motor means with an electronic motor control to drive the mechanical linkage means between a force resisting locked position and an open position and powering said motor to drive the linkage thereby unlocking the deadbolt means.

19. A method as claimed in claim 18, including providing microcomputer means for directing operation of said electronic motor control and motor.

20. A method as claimed in claim 19, wherein access control means is provided including provision for operating said locking system external to the door and cabinet.

21. A locking system for safes and the like wherein a door is locked and unlocked to a cabinet on which the door is pivotally mounted, comprising in combination, a deadbolt means carried either by the door or cabinet, mechanical linkage means for moving the deadbolt means for unlocking the door from the cabinet, a motor means connected for driving the mechanical linkage means from force resisting locked position to open position, and a motor control for operating the motor to drive the mechanical linkage means to unlock the deadbolt means between the door and cabinet.

22. A locking system as claim in claim 21, wherein said motor is rotatably connected for driving the mechanical linkage.

23. A locking system as claim in claim 22, wherein said motor is further rotatably connected for driving the mechanical linkage from open position to force resisting locked position and said motor control operates the motor to drive the mechanical linkage means to lock the deadbolt means between the door and cabinet.

24. A locking system as claimed in claim 21, wherein said motor means includes an access control means.

25. A locking system as claimed in claim 24, wherein said control includes a battery saver sleep mode and an operational mode upon input of an access signal.

26. A locking system as claimed in claim 21, wherein said motor is reversible and operable in two directions to move the deadbolt means.

27. A locking system as claimed in claim 21, wherein said motor is reversible and operable in one direction to move the deadbolt means.
